(19) United States
(12) Patent Application Publication
(10) Pub. No.: US 2005/0150256 A1
(43) Pub. Date: Jul. 14, 2005

(54) Fabrication of complex fiber grating structures by use of sequential writing with polarization control

(76) Inventors: Kai-Ping Chuang, Pingtung City (TW); Lih-Gen Sheu, Sinwu Township (TW); Meng-Chang Tsai, Hsinchu (TW); Yinchieh Lai, Hsinchu (TW)

Correspondence Address: RABIN & BERDO, P.C., Suite 500, 1101 14th Street, N.W., Washington, DC, 20005, US

(21) Appl. No.: 10/756,395

(22) Filed: Jan. 14, 2004

(51) Int. Cl. C03B 37/10; C03B 37/022

(52) U.S. Cl. 65/392; 65/386; 65/425

(57) ABSTRACT

The present invention provides a fabrication method of complex fiber grating structures that can be combined with prior fabrication methods including a phasemask or a two-beam interferometer. By using a rotatable half-wave plate with a polarization beam splitter in the optical path and precisely scanning the relative fiber position, we can expose true complex fiber gratings in a single scan by simultaneously rotating the angle of the half-wave plate.

### BACKGROUND OF THE INVENTION

1. Field of the Invention

The present invention generally relates to an exposure system and a method for fabricating a fiber grating and, more particularly, to an exposure system and a method for fabricating a complex fiber grating by use of sequential writing with polarization control.

2. Description of the Prior Art

When fabricating a fiber grating, refractive-index modulation and phase control are the most concerned parameters. It is therefore important to uniform the dc refractive-index modulation in addition to phase control during the exposure scan.

The Taiwan Patent Publication No. 436,667 discloses a method for fabricating a low-noise fiber grating by using a phase mask and an aperture so as to achieve uniform dc refractive-index modulation. Firstly in the method, a UV light passes through the aperture and then the phase mask as to form a grating in a photosensitive fiber. Secondly, the phase mask is moved backwards for a certain distance so that a non-interfered area (in the included angle of the first order diffracted light) serves as compensation of the refraction index of the fiber grating. Similarly, the U.S. Pat. No. 5,830,622 discloses a two-step method for modulating the variation of the refractive index. Firstly in the method, a grating is formed in the fiber. Secondly, light with pre-determined intensity distribution is irradiated on the grating. The above-referenced method is simple but requires a two-step exposure process. Moreover, the relation between the variation of the refractive index of the fiber and the light intensity for exposure is non-linear, resulting in critical control in light intensity in the second step exposure. As a matter of fact, these two prior art patents disclose methods that cannot be immune from non-uniform index of refraction and therefore the undesired noise.

In the U.S. Patent Publication No. 20020015919, there is therefore provided a method overcoming the afore-mentioned problems. In the method, two light beams with perpendicular polarization directions of electric fields are provided. An interference fringe pattern is formed behind a phase mask after the light beams are incident on the phase mask by an incident angle. Accordingly, the interference fringe pattern is adjusted by tuning the included angle of the light beams as well as the distance between the fiber and the grating so as to achieve modulation of the refractive index. Even though this method overcomes the problems brought forth by the Taiwan Patent Publication No. 436,667 and the U.S. Pat. No. 5,830,622, the phase difference in the interference fringe is very sensitive to precise control in the included angle between the light beams and the distance between the fiber and the phase mask. Moreover, the U.S. Pat. No. 5,367,588 discloses a grating with uniform derefractive-index modulation by using a specially designed phase mask. The phase mask has a period-variable grating as to compensate the variation of the refractive index of the fiber. Even though the phase mask is more convenient in use than the other prior art patents, it suffers from the high price. In addition, due to the lack of flexibility in designing the variation of the refractive index of the grating, different phase masks are required when various fiber gratings are to be exposed.

European Patent No. 1065535 discloses an apparatus including a light-enhancement screen mask in addition to a phase mask for exposure in the fiber. When both of the two screen masks are irradiated by the same light beam, the light intensity on different grating positions remains constant during the exposure scan. However, the application of this method is limited due to standard design of the light-enhancement screen mask, which lacks of changeability in modulation of refractive index.

Furthermore, a perturbation method can also be used. However, it requires an interferometer to precisely control the displacement of the fiber corresponding to the mask, which is very sensitive to the perturbation of the exposure system.

Therefore, the present invention has been made to solve the afore-mentioned problems in view of the forgoing status and to further provide an exposure system and a method for fabricating a complex fiber grating by use of sequential writing with polarization control.

### SUMMARY OF THE INVENTION

It is the primary object of the present invention to provide an exposure system and a method for fabricating a fiber grating, characterized in that only a single continuous exposure step is required to fulfill the variation of refractive index of any complex fiber grating, which effectively reduces the time, cost and difficulty in fabrication.

It is another object of the present invention to provide a method for fabricating a fiber grating, applicable to all kinds of conventional fiber gratings.

In one aspect of the present invention, an exposure system for a photosensitive fiber is provided as to form a grating in the photosensitive fiber. The exposure system comprises: a light source; a half-wave plate module; a polarization beam splitting prism; a reflection module; and an exposure module. The light source generates a light beam. The half-wave plate module converts the light beam into a polarized light beam with pre-determined polarization after the light beam passes through the half-wave plate module. The polarization beam splitting prism splits the polarized light beam into a first polarized light beam and a second polarized light beam.

The reflection module enables the first polarized light beam to irradiate on a pre-determined position in the photosensitive fiber after it is reflected in the reflection module. The exposure module enables the second polarized light beam to irradiate on the pre-determined position as to form the grating. More particularly, the first polarized light beam and the second polarized light beam have the same optical loss during the optical paths between the polarization beam splitting prism and the pre-determined position in the photosensitive fiber so that the photosensitive fiber is exposed to the first polarized light beam and the second polarized light beam that have the same light intensity.

Therefore, in the present invention, the half-wave plate module determines the polarization of the incident light beam and the light intensity ratio of the first polarized light beam and the second polarized light beam so as to control the refractive index modulation of the grating. In the meantime, the two light beams are incident on the same position in the photosensitive fiber such that the overall dc refractive-index modulation remains constant by use of sequential writing with polarization control. As a matter of fact, only a single exposure scan is required and thus reducing the time, cost and difficulty in fabrication.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a schematic diagram showing an exposure system in accordance with a first embodiment of the present invention;

FIG. 2 is a schematic diagram showing an exposure system in accordance with a second embodiment of the present invention;

FIG. 3 is a graph showing the relation between the rotation angle of the half-wave plate module in FIG. 1 and the exposure light intensity; and

FIG. 4 is a graph showing the reflection spectrum of the fiber grating of the present invention.

### DETAILED DESCRIPTION OF THE INVENTION

The present invention providing an exposure system and a method for fabricating a complex fiber grating by use of sequential writing with polarization control can be exemplified by the preferred embodiments as described hereinafter.

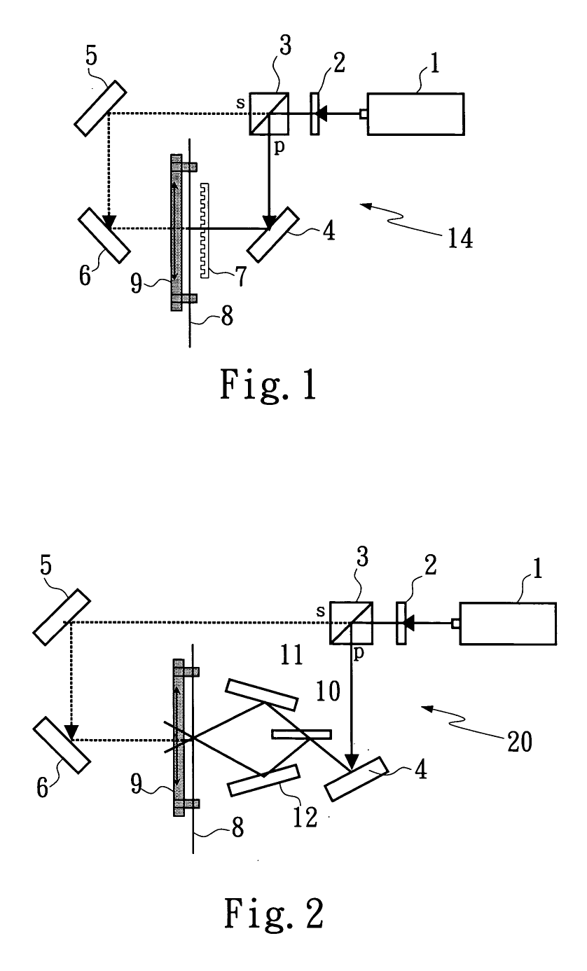

To start with, please refer to FIG. 1, which is a schematic diagram showing an exposure system 14 in accordance with a first embodiment of the present invention. The first embodiment of the present invention is shown as an exposure system 14 for forming a grating in a photosensitive fiber 8. The exposure system 14 comprises: a light source 1; a half-wave plate module 2; a polarization beam splitting prism 3; three reflection mirrors 4, 5, and 6; a phase mask 7; and a movable base 9.

The light source 1 generates a single-polarization light beam. In the first embodiment of the present invention, the light source 1 is a UV light source for generating a UV light beam. The UV light beam passes through the half-wave plate module 2. Since the half-wave plate module 2 has been tuned, it is able to convert the UV light beam into a polarized light beam with pre-determined polarization after the UV light beam passes through the half-wave plate module 2. According to the present invention, the half-wave plate module 2 includes a half-wave plate and a rotatable base. The half-wave plate is installed on the rotatable base such that the half-wave plate rotates around a pre-determined position as to enable the UV light beam to be converted into a polarized light beam with pre-determined polarization after the UV light beam passes through the half-wave plate module 2.

The polarization beam splitting prism 3 splits the polarized UV light beam into a first polarized light beam and a second polarized light beam after the polarized UV light beam passes through the polarization beam splitting prism 3. In the first embodiment of the present invention, the first polarized light beam is horizontally polarized and the second polarized light beam is vertically polarized.

As shown in FIG. 1, the horizontally polarized UV light beam travels horizontally until it reaches the reflection mirror 5 and subsequently the reflection mirror 6. The reflected polarized light beam is incident on a pre-determined in the photosensitive fiber 8 and thus the photosensitive fiber 8 is exposed, which however only causes the variation of refractive index of the fiber without forming a grating.

On the other hand, the vertically polarized UV light beam travels vertically until it reaches the reflection mirror 4 and is then reflected to pass through a phase mask 7 as an exposure module. The same pre-determined in the photosensitive fiber 8 is exposed to the UV light beam passing through the phase mask 7 and a grating is thus formed on the re-determined in the photosensitive fiber 8. Please note that the horizontally polarized UV light beam and the vertically polarized UV light beam have the same optical loss during the optical paths between the polarization beam splitting prism 3 and the pre-determined position in the photosensitive fiber 8 so that the photosensitive fiber 8 is exposed to the horizontally polarized UV light beam and the vertically polarized UV light beam that have the same total intensity across a whole grating length.

The movable base 9 has nanometer-scale resolution such that the photosensitive fiber 8 on the movable base 9 moves in nanometer-scale, resulting in continuous exposure on the photosensitive fiber and thus complicated structure of fiber grating.

Please further refer to FIG. 2, which is a schematic diagram showing an exposure system 20 in accordance with a second embodiment of the present invention. The second embodiment of the present invention is shown as an exposure system 20, which is different from the exposure system 14 of the first embodiment in that the exposure module of the exposure system 20 differs from the exposure module of the exposure system 14. More particularly, the exposure system 14 uses a phase mask, while the exposure system 20 employs a two-beam interferometer. In the exposure system 20, after being reflected by the reflection mirror 4, the vertically polarized UV light beam is split by a beam splitter 10 into a first split light beam and a second split light beam. The first split light beam is reflected by a reflection mirror 11 and is thus incident on a pre-determined position in the photosensitive fiber 8, and the second split light beam is reflected by a reflection mirror 12 and is thus incident on the pre-determined position in the photosensitive fiber 8. A grating is thus formed. Since the exposure system 20 does not employ a phase mask, the movable base only controls the movement of the photosensitive fiber 8.

Accordingly, the present invention can be embodied by adding a beam splitting system to both the conventional phase mask exposure system and the conventional two-beam interference exposure system. The present invention is thus useful.

Please refer to FIG. 1 as reference to a method for fabricating a fiber grating according to the first embodiment of the present invention:

Step 1: providing close to a phase mask 7 a photosensitive fiber 8 on a continuously movable base 9, wherein the displacement of the movable base 9 is measured by use of an interferometer;

Step 2: forming a grating in the photosensitive fiber 8 by exposing a pre-determined position in the photosensitive fiber to a vertically polarized UV light beam after the vertically polarized UV light beam passes through a beam splitting system comprising a half-wave plate module and a polarization beam splitting prism, while the pre-determined position is exposed to a horizontally polarized UV light beam that only causes the variation of refractive index; and

Step 3: tuning the horizontally polarized UV light beam and the vertically polarized UV light beam to have the same optical loss during the optical paths between the polarization beam splitting prism 3 and the pre-determined position in the photosensitive fiber 8 so that the photosensitive fiber 8 is exposed to the horizontally polarized UV light beam and the vertically polarized UV light beam that have the same total intensity across a whole grating length.

Similarly, a method according to the second embodiment of the present invention can be achieved by replacing the phase mask with a two-beam interferometer as shown in FIG. 2.

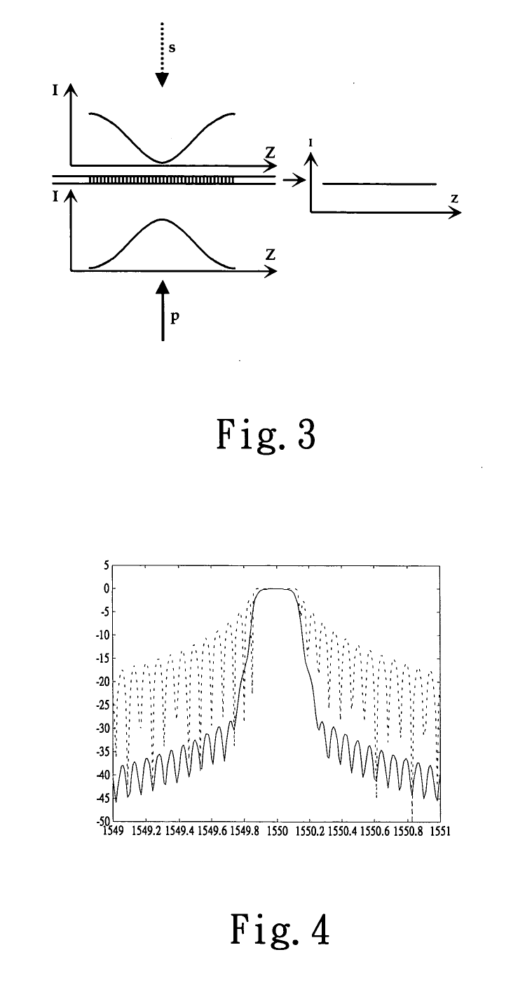

Experimental results are also provided as to assert the enablement of the present invention. Please refer to FIG. 3, which is a graph showing the relation between the rotation angle of the half-wave plate module in FIG. 1 and the exposure light intensity. In FIG. 3, the distribution of refractive index is uniform after rotating the half-wave plate. Please further refer to FIG. 4, which is a graph showing the reflection spectrum of the fiber grating of the present invention. In FIG. 4, the dotted line represents the reflection spectrum of the fiber grating without pure a podization, while the solid line represents the reflection spectrum of the fiber grating with pure apodization. A conclusion is made that a fiber grating with pure apodization has less noise.

In summary, the present invention has advantages over the prior art patents:
1. Only a single continuous exposure step is required to fulfill pure apodized fiber gratings, which increases the precision of refractive index modulation.
2. Polarization control is used to modulate the refractive index change, which is more reliable and less costly than the conventional arts.
3. The present invention can be applied in the conventional phase mask exposure system and the conventional two-beam interference exposure systems, thus enhancing the utility.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

1. A beam splitting system for splitting a light beam from a light source into two light beams with different polarization modes, the beam splitting system comprising:
a half-wave plate module for converting the light beam into a polarized light beam with pre-determined polarization after the light beam passes through the half-wave plate module; and
a polarization beam splitting prism for splitting the polarized light beam into a first polarized light beam and a second polarized light beam.

2. The beam splitting system as recited in claim 1, wherein the half-wave plate module comprises a half-wave plate as to enable the light beam to be polarized with a pre-determined polarization direction.

3. The beam splitting system as recited in claim 2, wherein the half-wave plate module comprises a rotatable base as to carry the half-wave plate such that the half-wave plate rotates around a pre-determined position as to enable the light beam to pass through the half-wave plate and be polarized with the pre-determined polarization direction.

4. The beam splitting system as recited in claim 1, wherein the first polarized light beam has a horizontal polarization mode.

5. The beam splitting system as recited in claim 1, wherein the second polarized light beam has a vertical polarization mode.

6. The beam splitting system as recited in claim 1, wherein the light source is a UV light source and the light beam is a UV light beam.

7. An exposure system for forming a grating on a photosensitive fiber, the exposure system comprising:
a light source, for generating a light beam;
a half-wave plate module for converting the light beam into a polarized light beam with pre-determined polarization after the light beam passes through the half-wave plate module;
a polarization beam splitting prism for splitting the polarized light beam into a first polarized light beam and a second polarized light beam;
a reflection module, enabling the first polarized light beam to irradiate on a pre-determined position in the photosensitive fiber after it is reflected in the reflection module; and
an exposure module, enabling the second polarized light beam to irradiate on the pre-determined position as to form the grating;
wherein the first polarized light beam and the second polarized light beam have the same optical loss during the optical paths between the polarization beam splitting prism and the pre-determined position in the photosensitive fiber so that the photosensitive fiber is exposed to the first polarized light beam and the second polarized light beam that have the same total intensity across a whole grating length..

8. The exposure system as recited in claim 7, wherein the half-wave plate module comprises a half-wave plate as to enable the light beam to be polarized with a pre-determined polarization direction.

9. The exposure system as recited in claim 8, wherein the half-wave plate module comprises a rotatable base as to carry the half-wave plate such that the half-wave plate rotates around a pre-determined position as to enable the light beam to pass through the half-wave plate and be polarized with the pre-determined polarization direction.

10. The exposure system as recited in claim 7, wherein the first polarized light beam has a horizontal polarization mode and the second polarized light beam has a vertical polarization mode.

11. The exposure system as recited in claim 7, wherein the light source is a UV light source and the light beam is a UV light beam.

12. The exposure system as recited in claim 7, wherein the exposure module is a phase mask so that the grating is formed in the photosensitive fiber by exposing the photosensitive fiber to the second polarized light beam.

13. The exposure system as recited in claim 12, wherein the first polarized light beam, after being reflected by the reflection module, causes the variation of refractive index of the photosensitive fiber without forming the grating.

14. The exposure system as recited in claim 13, wherein the photosensitive fiber and the phase mask are installed on a movable base so that the photosensitive fiber is continuously exposed.

15. The exposure system as recited in claim 7, wherein the exposure module is a two-beam interferometer so that the grating is formed in the photosensitive fiber by exposing the photosensitive fiber to the second polarized light beam.

16. The exposure system as recited in claim 15, wherein the first polarized light beam, after being reflected by the reflection module, causes the variation of refractive index of the photosensitive fiber without forming the grating.

17. The exposure system as recited in claim 16, wherein the photosensitive fiber is installed on a movable base so that the photosensitive fiber is continuously exposed.

18. An exposure method for forming a grating on a photosensitive fiber, the exposure method comprising steps of:
providing a light source, for generating a light beam;
providing a half-wave plate module for converting the light beam into a polarized light beam with pre-determined polarization after the light beam passes through the half-wave plate module;
providing a polarization beam splitting prism for splitting the polarized light beam into a first polarized light beam and a second polarized light beam;
providing a reflection module, enabling the first polarized light beam to irradiate on a pre-determined position in the photosensitive fiber after it is reflected in the reflection module; and
providing an exposure module, enabling the second polarized light beam to irradiate on the pre-determined position as to form the grating;
wherein the first polarized light beam and the second polarized light beam have the same optical loss during the optical paths between the polarization beam splitting prism and the pre-determined position in the photosensitive fiber so that the photosensitive fiber is exposed to the first polarized light beam and the second polarized light beam that have the same total intensity across a whole grating length.

19. The exposure method as recited in claim 18, wherein the half-wave plate module comprises a half-wave plate as to enable the light beam to be polarized with a pre-determined polarization direction.

20. The exposure method as recited in claim 19, wherein the half-wave plate module comprises a rotatable base as to carry the half-wave plate such that the half-wave plate rotates around a pre-determined position as to enable the light beam to pass through the half-wave plate and be polarized with the pre-determined polarization direction.

21. The exposure method as recited in claim 18, wherein the first polarized light beam has a horizontal polarization mode and the second polarized light beam has a vertical polarization mode.

22. The exposure method as recited in claim 18, wherein the light source is a UV light source and the light beam is a UV light beam.

23. The exposure method as recited in claim 18, wherein the exposure module is a phase mask so that the grating is formed in the photosensitive fiber by exposing the photosensitive fiber to the second polarized light beam.

24. The exposure method as recited in claim 23, wherein the first polarized light beam, after being reflected by the reflection module, causes the variation of refractive index of the photosensitive fiber without forming the grating.

25. The exposure method as recited in claim 24, wherein the photosensitive fiber and the phase mask are installed on a movable base so that the photosensitive fiber is continuously exposed.

26. The exposure method as recited in claim 18, wherein the exposure module is a two-beam interferometer so that the grating is formed in the photosensitive fiber by exposing the photosensitive fiber to the second polarized light beam.

27. The exposure method as recited in claim 26, wherein the first polarized light beam, after being reflected by the reflection module, causes the variation of refractive index of the photosensitive fiber without forming the grating.

28. The exposure method as recited in claim 27, wherein the photosensitive fiber is installed on a movable base so that the photosensitive fiber is continuously exposed.
